(19) United States
(12) Patent Application Publication
(10) Pub. No.: US 2015/0287176 A1
(43) Pub. Date: Oct. 8, 2015

(54) METHOD AND APPRATUS FOR HYBRID TEST PATTERN GENERATION FOR OPC MODEL CALIBRATION

(71) Applicant: GLOBALFOUNDRIES Inc., Grand Cayman (KY)

(72) Inventors: Tamer COSKUN, San Jose, CA (US); Yi ZOU, Foster City, CA (US)

(73) Assignee: GLOBALFOUNDRIES Inc., Grand Cayman (KY)

(21) Appl. No.: 14/243,528

(22) Filed: Apr. 2, 2014

(51) Int. Cl. G06T 7/00

(52) U.S. Cl. CPC G06T 7/001

(57) ABSTRACT

A method and apparatus for hybrid test pattern generation for optical proximity correction (OPC) model calibration is disclosed. Embodiments may include receiving a mask pattern of a chip layout, extracting one or more patterns from the mask pattern, determining one or more parametric data sets for the one or more patterns, retrieving one or more calibration parametric data sets based on one or more other mask patterns, determining a difference between the one or more parametric data sets and the one or more calibration parametric data sets, and adding the one or more parametric data sets to the one or more calibration parametric data sets if the difference satisfies a threshold value.

### TECHNICAL FIELD

The present disclosure relates to optical proximity correction (OPC) of a mask pattern for an integrated circuit (IC). The present disclosure particularly relates to the calibration of OPC models utilized for simulating a final mask pattern.

### BACKGROUND

OPC models are typically calibrated against wafer data based on a limited number of mask patterns. The number of mask patterns is purposely limited to reduce the complexity of the calibration process and the cost associated with preparation of the wafer data. However, the selection of mask patterns presents challenges because the selected patterns must reflect the variation exhibited by actual design content. At the same time, the selected mask patterns must be able to trigger the sensitivity of OPC model parameters. Merely including patterns with greater or different variations is not a viable solution because the cost of collecting and extracting wafer data may exceed its benefits due to redundancy in the data. It may even confuse model-based calibration techniques.

A need therefore exists for methodology and a corresponding apparatus enabling selection of test patterns that represent the design domain while reducing redundant wafer data collection.

### SUMMARY

An aspect of the present disclosure is a hybrid test pattern generation method for OPC model calibration. The hybrid method is capable of selecting mask patterns based on the geometric content of the design as well as the sensitivity of the OPC model to the geometric content.

Another aspect of the present disclosure is a metric that quantifies the geometric and optical variations of a test pattern.

Additional aspects and other features of the present disclosure will be set forth in the description which follows and in part will be apparent to those having ordinary skill in the art upon examination of the following or may be learned from the practice of the present disclosure. The advantages of the present disclosure may be realized and obtained as particularly pointed out in the appended claims.

According to the present disclosure, some technical effects may be achieved in part by a method including: receiving a mask pattern of a chip layout, extracting one or more patterns from the mask pattern, determining one or more parametric data sets for the one or more patterns, retrieving one or more calibration parametric data sets based on one or more other mask patterns, determining a difference between the one or more parametric data sets and the one or more calibration parametric data sets, and adding the one or more parametric data sets to the one or more calibration parametric data sets if the difference satisfies a threshold value.

Aspects of the present disclosure include determining one or more components of the one or more patterns and generating one or more flat matrices by removing dimension information of the one or more components. Additional aspects include the one or more parametric data sets including the one or more flat matrices. Further aspects include determining one or more ranges for the dimension information and generating one or more dimension matrices for the one or more patterns based on the one or more ranges. Additional aspects include the one or more parametric data sets including the one or more dimension matrices. Further aspects include determining one or more response matrices based on one or more responses of the one or more components to one or more variables of a lithography process. Additional aspects include the one or more parametric data sets including the one or more response matrices. Further aspects include the one or more variables including an intensity variable, a resist contour, an aerial image, or a combination thereof. Additional aspects include generating a combined matrix based on the one or more flat matrices, the one or more dimension matrices, and the one or more response matrices. Further aspects include retrieving a calibration matrix based on the one or more other mask patterns and determining a difference matrix based on a difference between the combined matrix and the calibration matrix. Additional aspects include determining a difference metric based on the difference matrix. Further aspects include the difference metric being a Euclidean, zero, or a p-norm of the difference matrix.

Another aspect of the present disclosure is an apparatus including at least one processor and at least one memory including computer program code for one or more programs, the at least one memory and the computer program code configured to, with the at least one processor, cause the apparatus to perform: receive a mask pattern of a chip layout, extract one or more patterns from the mask pattern, determine one or more parametric data sets for the one or more patterns, retrieve one or more calibration parametric data sets based on one or more other mask patterns, determine a difference between the one or more parametric data sets and the one or more calibration parametric data sets, and add the one or more parametric data sets to the one or more calibration parametric data sets if the difference satisfies a threshold value.

Aspects include the apparatus further being caused to determine one or more components of the one or more patterns and generate one or more flat matrices by removing dimension information of the one or more components, the one or more parametric data sets including the one or more flat matrices. Additional aspects include the apparatus further being caused to determine one or more ranges for the dimension information and generate one or more dimension matrices for the one or more patterns based on the one or more ranges, the one or more parametric data sets including the one or more dimension matrices. Further aspects include the apparatus further being caused to determine one or more response matrices based on one or more responses of the one or more components to one or more variables of a lithography process, the one or more parametric data sets including the one or more response matrices. Additional aspects include the one or more variables including an intensity variable, a resist contour, an aerial image, or a combination thereof. Further aspects include the apparatus further being caused to generate a combined matrix based on the one or more flat matrices, the one or more dimension matrices, and the one or more response matrices. Additional aspects include the apparatus further being caused to retrieve a calibration matrix based on the one or more other mask patterns, and determine a difference matrix based on a difference between the combined matrix and the calibration matrix. Further aspects include the apparatus further being caused to determine a difference metric based on the difference matrix, the difference metric being a Euclidean, zero, or a p-norm of the difference matrix.

Another aspect of the present disclosure is a hybrid test pattern generation method, the method including: receiving a mask pattern of a chip layout, extracting one or more patterns from the mask pattern, determining one or more components of the one or more patterns, generating one or more flat matrices by removing dimension information of the one or more components, determining one or more ranges for the dimension information, generating one or more dimension matrices for the one or more patterns based on the one or more ranges, determining one or more response matrices based on one or more responses of the one or more components to one or more variables of a lithography process, and generating a combined matrix based on the one or more flat matrices, the one or more dimension matrices, and the one or more response matrices. Additional aspects include retrieving a calibration matrix based on the one or more other mask patterns, and determining a difference matrix based on a difference between the combined matrix and the calibration matrix. Further aspects include determining a difference metric based on the difference matrix, the difference metric being a Euclidean, zero, or a p-norm of the difference matrix. Additional aspects include the one or more variables including an intensity variable, a resist contour, an aerial image, or a combination thereof.

Additional aspects and technical effects of the present disclosure will become readily apparent to those skilled in the art from the following detailed description wherein embodiments of the present disclosure are described simply by way of illustration of the best mode contemplated to carry out the present disclosure. As will be realized, the present disclosure is capable of other and different embodiments, and its several details are capable of modifications in various obvious respects, all without departing from the present disclosure. Accordingly, the drawings and description are to be regarded as illustrative in nature, and not as restrictive.

### BRIEF DESCRIPTION OF THE DRAWINGS

The present disclosure is illustrated by way of example, and not by way of limitation, in the figures of the accompanying drawing and in which like reference numerals refer to similar elements and in which:

FIG. 1 illustrates a process flow for a hybrid test pattern generation, in accordance with an exemplary embodiment of the present disclosure;

FIGS. 2A and 2B illustrate a flattening operation, in accordance with an exemplary embodiment of the present disclosure;

FIGS. 3A and 3B illustrate a response operation, in accordance with an exemplary embodiment of the present disclosure;

FIGS. 4A and 4B illustrate a dimension operation, in accordance with an exemplary embodiment of the present disclosure;

FIGS. 5A and 5B illustrate process flows for a hybrid test pattern generation, in accordance with another exemplary embodiment of the present disclosure; and

FIG. 6 illustrates a computer system for implementing a hybrid test pattern generator, in accordance with an exemplary embodiment of the present disclosure.

### DETAILED DESCRIPTION

In the following description, for the purposes of explanation, numerous specific details are set forth in order to provide a thorough understanding of exemplary embodiments. It should be apparent, however, that exemplary embodiments may be practiced without these specific details or with an equivalent arrangement. In other instances, well-known structures and devices are shown in block diagram form in order to avoid unnecessarily obscuring exemplary embodiments. In addition, unless otherwise indicated, all numbers expressing quantities, ratios, and numerical properties of ingredients, reaction conditions, and so forth used in the specification and claims are to be understood as being modified in all instances by the term “about.”

The present disclosure addresses and solves the current problem of ad-hoc wafer data collection and its cost or redundant data or insufficient data variation attendant upon limiting test patterns to reduce OPC model calibration complexity. In accordance with embodiments of the present disclosure, a hybrid test pattern generation technique is utilized to select mask patterns for inclusion in an OPC model, such that the hybrid technique defines a quantifiable metric that takes into account both the geometric and optical properties of a candidate mask pattern.

Methodology in accordance with embodiments of the present disclosure includes: receiving a mask pattern of a chip layout, extracting one or more patterns from the mask pattern, determining one or more parametric data sets for the one or more patterns, retrieving one or more calibration parametric data sets based on one or more other mask patterns, determining a difference between the one or more parametric data sets and the one or more calibration parametric data sets, and adding the one or more parametric data sets to the one or more calibration parametric data sets if the difference satisfies a threshold value.

Still other aspects, features, and technical effects will be readily apparent to those skilled in this art from the following detailed description, wherein preferred embodiments are shown and described, simply by way of illustration of the best mode contemplated. The disclosure is capable of other and different embodiments, and its several details are capable of modifications in various obvious respects. Accordingly, the drawings and description are to be regarded as illustrative in nature, and not as restrictive.

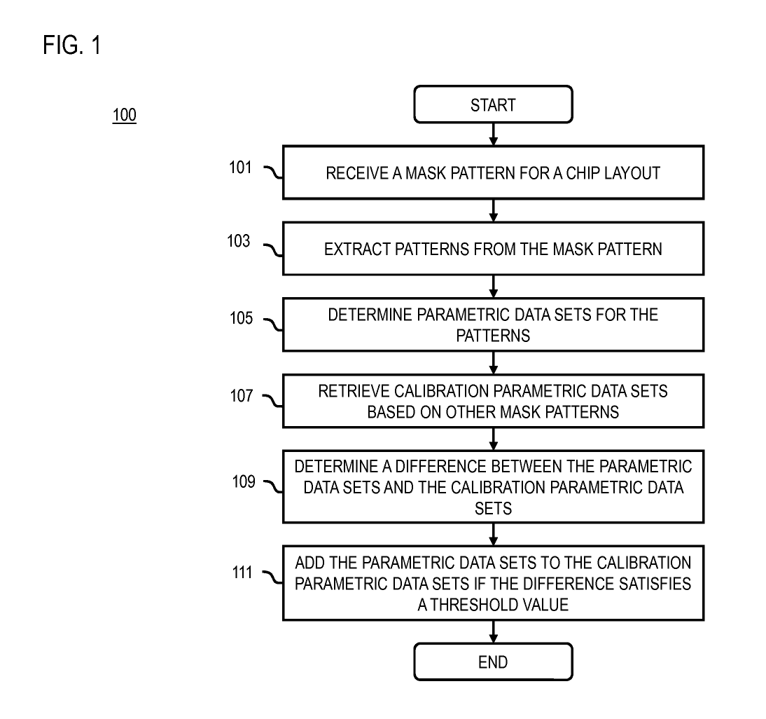

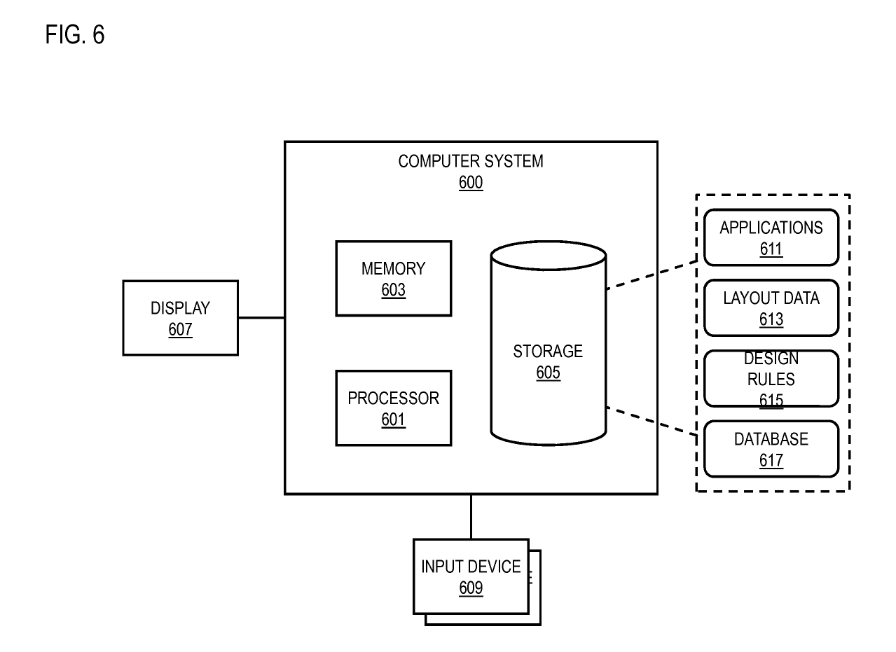

FIG. 1 illustrates a process flow 100 for a hybrid test pattern generation, in accordance with an exemplary embodiment of the present disclosure. The process 100 may be implemented in, for instance, a chip set including a processor and a memory as shown in FIG. 6. In step 101, a mask pattern for a chip layout may be received. For instance, the mask pattern may be a candidate pattern for inclusion in an OPC model. In step 103, one or more patterns may be extracted from the mask pattern. For instance, the mask pattern may be scanned to determine if there are any new or unique feature patterns not previously utilized in the OPC model.

In step 105, one or more parametric data sets are determined for the extracted patterns. Each parametric data set may reflect the properties of an extracted pattern with respect to either its geometric or optical properties. For instance, the x and y dimensions of components in the extracted mask pattern may be stored in corresponding dimension matrices. Similarly, the intensity properties of a lithographic process for the extracted mask pattern may be stored in various response matrices. The separation of such features into separate matrices allows subsequent manipulation and analysis of the overall mask pattern for selection in an OPC model.

In step 107, one or more calibration parametric data sets are retrieved based on other mask patterns. For instance, the calibration parametric data sets may currently be in use in the OPC model. In step 109, a difference between the parametric data sets and the calibration parametric data sets is determined. For instance, the difference may be a metric for a mathematical absolute difference between matrices representing the parametric data sets and the calibration parametric data sets. The metric may be determined as a norm of the difference matrix. For instance, the metric may be equal to a Euclidean, zero or p-norm of the parametric data sets. The difference may also be determined as a mathematical absolute difference between metrics of the parametric data sets and the calibration parametric data sets.

In step 111, the one or more parametric data sets are added to the calibration parametric data sets if the difference determined in step 109 satisfies a threshold value. For instance, the absolute difference in the metric values for the candidate mask pattern and the calibration data may exceed a configured value. This may indicate, for example, a sufficient variation or sensitivity to OPC model parameters of the received mask pattern.

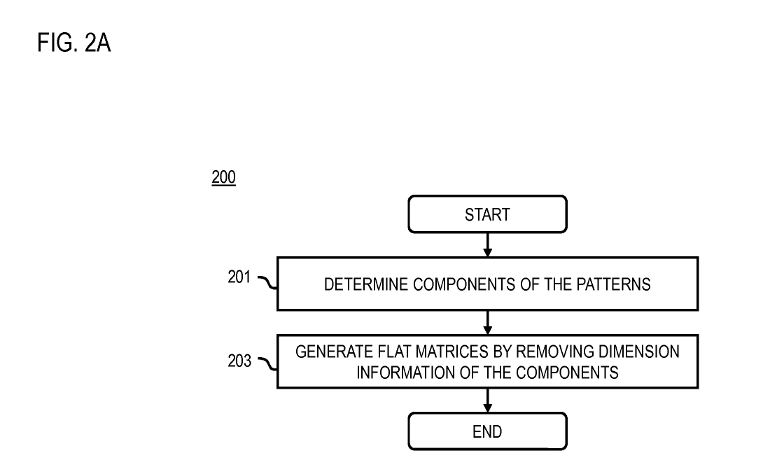

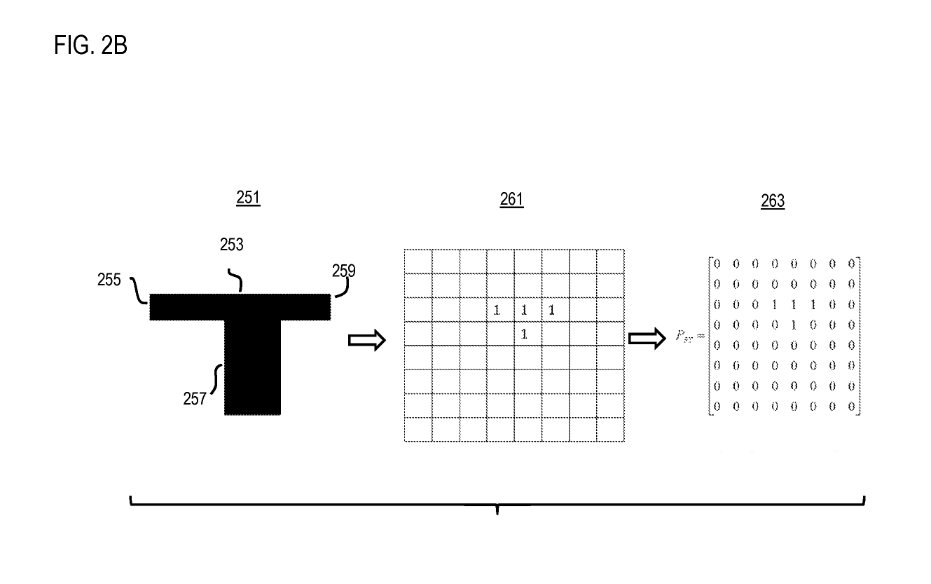

FIG. 2A illustrates a process flow 200 for a flattening operation, in accordance with an exemplary embodiment of the present disclosure. The process flow 200 may be implemented in, for instance, a chip set including a processor and a memory as shown in FIG. 6. In step 201, one or more components of an extracted pattern are determined. For instance, a T-shaped feature may have a component for each vertical and horizontal feature. In step 203, flat matrices are generated by removing dimension information from the components identified in step 201. For instance, the mask pattern may include x and y dimensions for each component. This dimension information may be removed by the flattening operation.

The flattening operation is illustrated with respect to FIG. 2B. A T-shaped pattern 251 has four components 253-259. A flattening operation results in the flattened mask pattern 261. As shown, the flat representation only includes a “1” value at the location of each component but lacks any dimension information. The flattened mask may be represented by the flat matrix 263 (P_{FT}). The flat matrix 263 has all dimension information removed such that, for example, all T-shaped patterns may be represented by the same matrix regardless of individual variations in the height or width of their respective individual component features. The flattening operator may be represented in mathematical form as:

P_{FT}=FT(P) (1)

An inverse operation to the flattening operator may exist by which the flattened pattern P_{FT} may be transformed back into a mask pattern. However, in order to perform the inverse flattening, the dimension information for each component of the pattern must be preserved.

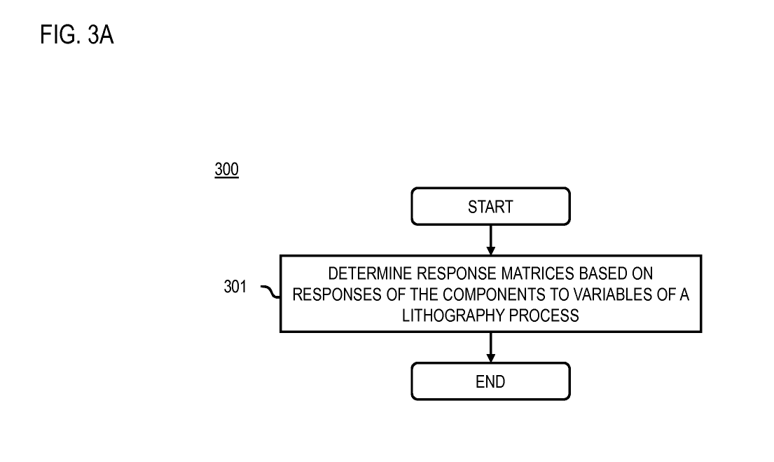

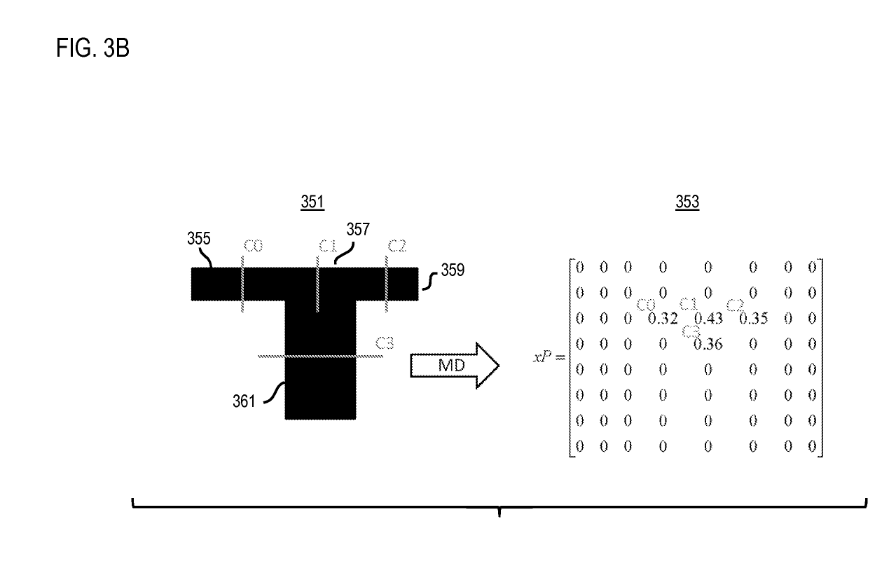

FIG. 3A illustrates a process flow 300 for generating one or more response matrices, in accordance with an exemplary embodiment of the present disclosure. The process flow 300 may be implemented in, for instance, a chip set including a processor and a memory as shown in FIG. 6. In step 301, one or more response matrices may be determined based on responses of the components identified in step 201 to variables of a lithography process.

FIG. 3B illustrates a response operation, according to an exemplary embodiment of the present invention. For instance, a response operation may take the patterns extracted in step 201 and generate a parametric value associated with each component element of the flattened mask pattern 255. Thus, for instance, the pattern 351 is operated on by a response operator (MD) to generate the response matrix 353 (xP). As shown, the response matrix 353 has non-zero values representing a response of the components 355-361 to a specific process variable. For instance, the non-zero values 0.32, 0.43, 0.35, and 0.36 correspond to the maximum intensity measured at the lines C0-C3.

To obtain the response, process simulation models may be utilized. For instance, the patterns may be passed through a lithography simulator to generate an intensity response of the pattern to a lithography process. The simulation may be conducted, for example, assuming an aerial image. The aerial image, for instance, may be obtained by applying a threshold value to an optical image formed in a resist material or wafer. The input to the response operator will be the intensity generated by the imaging system for a given pattern under specific process conditions. For instance, the intensity response may be calculated by using the Hopkins formulation given by:

I(r)=Σ_{k′}^{k}M(k)×conj(M(k′))×TCC(k,k′)e^{i(k-k′)×r} (2)

Here, M is a Fourier transformation of the mask pattern, TCC represents the imaging system, conj is the complex conjugate operator, r is the position vector, and k, k′ are the wave number vectors of the Hopkins formulation.

Optionally, the mask pattern may be passed through a resist simulator to obtain a simulated resist contour of the mask pattern. Any public or proprietary resist model may be used to model different variations. For instance, the resist contour may be defined as a solution to:

R{I(r)}=th (3)

Both the lithography and resist models may be combined and represented as a single operator MD defined as:

xP=MD(P) (4)

Here, the input to the MD operator is the polygon P and the output xP is a matrix having the same dimensions as P_{FT}. The xP matrix will have non-zero values for the cells that have a “1” value in the P_{FT} matrix. The values may correspond, for instance, to an intensity parameter. For example, the values may include a maximum intensity (Imax), a minimum intensity (Imin), an image slope, and a curvature.

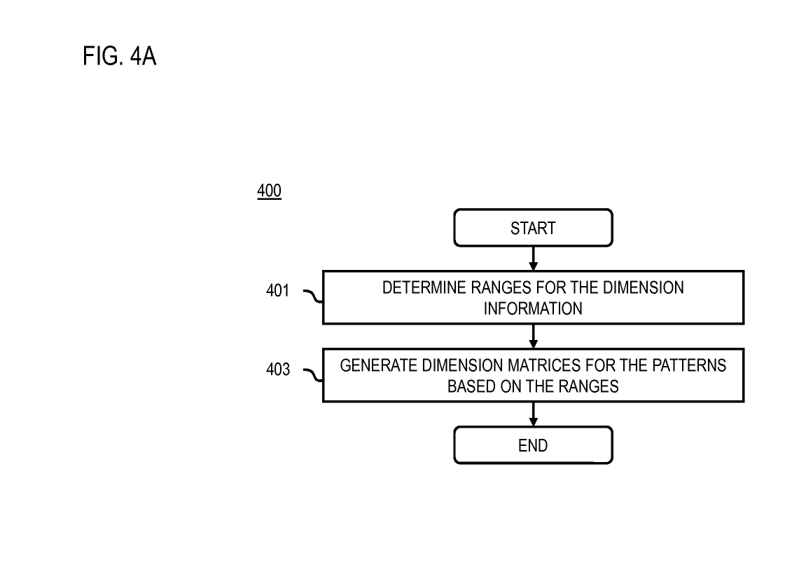

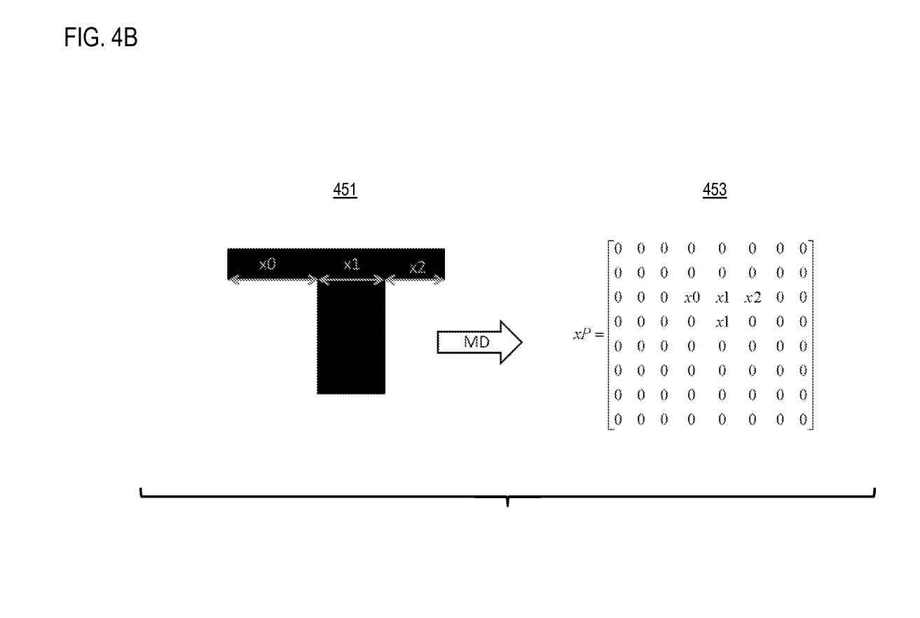

FIG. 4A illustrates a process flow 400 for generating one or more dimension matrices, in accordance with an exemplary embodiment of the present disclosure. The process 400 may be implemented in, for instance, a chip set including a processor and a memory as shown in FIG. 6. In step 401, range values for the dimension information are determined. For instance, the x or y dimension information of the extracted mask patterns in step 201 may be retrieved from the original input mask. In step 403, dimension matrices are generated for the patterns based on the ranges. For instance, the range information obtained in step 401 may be inserted into a matrix such that the only non-zero values correspond to an x or y dimension (depending on the dimension being examined) of a pattern component.

FIG. 4B illustrates a dimension operator, in accordance with an exemplary embodiment of the present disclosure. For instance, the MD operator described in relation to FIGS. 3A and 3B may also be used to capture the geometric information of a mask pattern. Thus, for instance, FIG. 4B illustrates an MD operation that captures the x-dimension information 451 of the mask pattern 453. Each non-zero value of the dimension matrix 455 represents the captured x-dimension. The MD operation may similarly be used to capture the y-dimension information of the mask pattern.

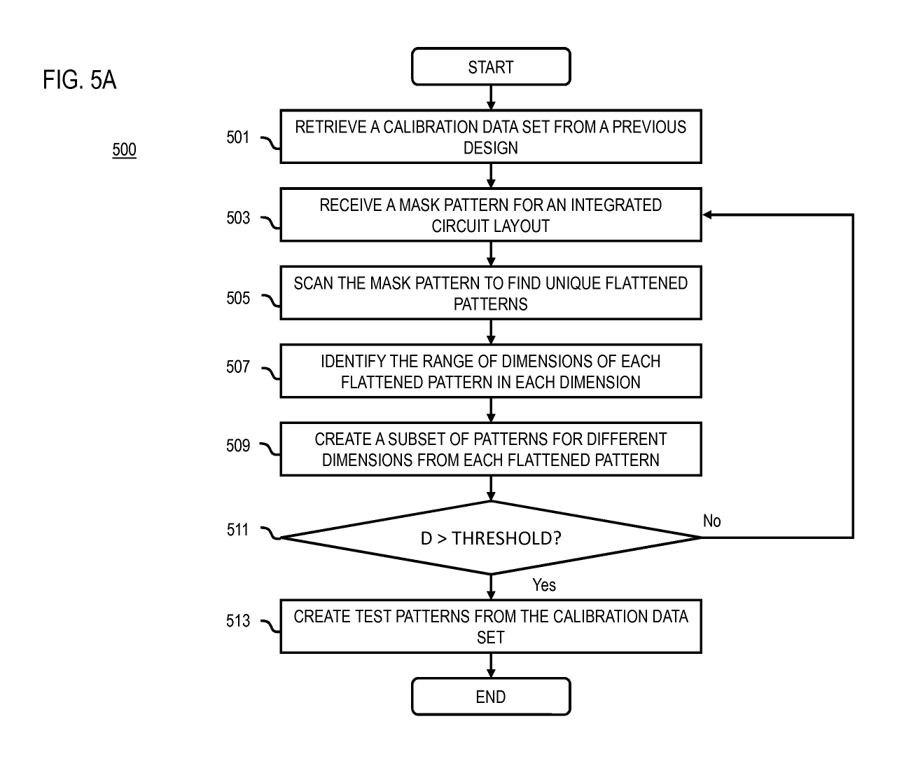

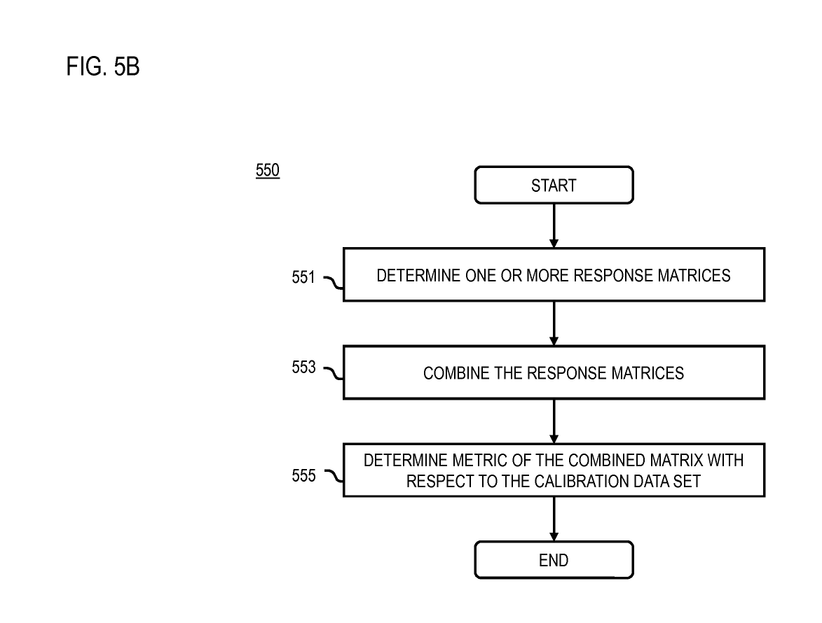

FIG. 5A illustrates a process flow 500 for a hybrid test pattern generation, in accordance with another exemplary embodiment of the present disclosure. The process 500 may be implemented in, for instance, a chip set including a processor and a memory as shown in FIG. 6. In step 501, a calibration data set is retrieved from a previous design. This step may be skipped if it is for a completely new process. In step 503, a mask pattern for an IC layout (e.g., full chip layout) is received. For instance, the IC layout may be a potential candidate for inclusion in an OPC model.

In step 505, the received mask pattern is scanned to find unique flattened patterns. For instance, the mask pattern information may be read into one or more pattern matrices and flattened to remove all dimension information. The dimension information may be separately stored such that it can be later retrieved to recreate the mask pattern. In step 507, ranges for the dimensions of each component in the flattened mask are identified. For instance, the x and y dimension information of a component may be included in a received 2D mask pattern. In step 509, a subset of patterns for different dimensions is generated from each flattened pattern. For instance, one or more dimension matrices containing the identified dimension information may be generated. In step 511, a metric (D) of the mask pattern is compared to a threshold value. If the metric exceeds the threshold value, the mask pattern is added to the calibration parametric data set (step 513). Otherwise, the process discards the mask pattern and repeats the process 500 beginning at step 503.

FIG. 5B illustrates a process flow 550 for determining the metric used to select a mask pattern, in accordance with an exemplary embodiment of the present disclosure. The process 550 may be implemented in, for instance, a chip set including a processor and a memory as shown in FIG. 6. In step 551, one or more response matrices are determined. The response matrices, for instance, may be determined based on an intensity response of the mask pattern for a particular lithographic process. The response matrices may also be determined based on a resist simulation for the lithographic process. Various models (e.g., Hopkins formulation) may be used to simulate the response of the mask pattern. It is contemplated that other factors of lithography that impact accurate reproduction of the mask pattern may also be used to determine various additional response matrices.

In step 553, the one or more response matrices are combined. The combined matrix may be a larger matrix. For example, the response and dimension matrices (xP) described in relation to FIGS. 3B and 4B may be combined into a single, larger matrix. The combined, larger, matrix (xP_{ALL}) may be represented by:

xP_{ALL}=[a₀P_{FT}; a₁xP₁; a₂xP₂; . . . ; a_{N}xP_{N}] (5)

The xP_{ALL} matrix combines the pattern geometry as represented by the flattened pattern matrix P_{FT} with the modeled lithographic responses as represented by the response matrices xP. For instance, the xP response may be the intensity response of the imaging system utilized by the lithography process. The coefficients aᵢ (i=0 . . . N) are used as weighting coefficients that together define a balance between the geometric and optical properties of the mask pattern.

The xP_{ALL} matrix may be used to identify the similarity between two mask patterns based on one or more selected properties. Each property (e.g., geometric, intensity response) may be selected or weighted by setting the corresponding coefficient (aᵢ) to the appropriate value. For instance, the rough geometric similarity between any two patterns may be determined by setting all the coefficients save a₀ to zero. The resulting matrix may then be utilized to compare the similarity in terms of purely geometric features. Similarly, by also setting the coefficient a₁ to a non-zero value, the x-dimensions of the two mask patterns may also be compared. Thus, the relative weighting of the coefficients provides an additional lever that can be used to give different weight to a particular property when making the comparison.

In step 555, a metric is determined for the combined matrix with respect to the calibration data set. For instance, the metric may be determined as follows:

D=Norm{xP_{ALL1}−xP_{ALL2}} (6)

The Norm function may be defined as, for instance, a two-dimensional Euclidean norm, a zero norm, or a p-norm of the matrix representing the difference between the combined matrix and a calibration matrix obtained from a previous design.

Although the discussion herein describes use of the metric D to select mask patterns for OPC models, it is contemplated that the same or similar methodology may be utilized for classifying or analyzing mask patterns for printability. It is further contemplated that the methodology may also be used to select patterns for the verification of OPC models.

The processes described herein may be implemented via software, hardware, firmware, or a combination thereof. Exemplary hardware (e.g., computing hardware) is schematically illustrated in FIG. 6. As shown, computer system 600 includes at least one processor 601, at least one memory 603, and at least one storage 605. Computer system 600 may be coupled to display 607 and one or more input devices 609, such as a keyboard and a pointing device. Display 607 may be utilized to provide one or more GUI interfaces. Input devices 609 may be utilized by users of computer system 600 to interact with, for instance, the GUI interfaces. Storage 605 may store applications 611, layout data (or information) 613, design rules 615, and at least one shape and/or cell database (or repository) 617. Applications 611 may include instructions (or computer program code) that when executed by processor 601 cause computer system 600 to perform one or more processes, such as one or more of the processes described herein. In exemplary embodiments, applications 611 may include one or more manufacturability analysis and/or yield enhancement tools.

The embodiments of the present disclosure can achieve several technical effects, including improved selection of mask patterns for OPC models and reduced costs associated with redundant wafer data collection. The present disclosure enjoys industrial applicability associated with the designing and manufacturing of any of various types of highly integrated semiconductor devices used in microprocessors, smart phones, mobile phones, cellular handsets, set-top boxes, DVD recorders and players, automotive navigation, printers and peripherals, networking and telecom equipment, gaming systems, and digital cameras.

In the preceding description, the present disclosure is described with reference to specifically exemplary embodiments thereof. It will, however, be evident that various modifications and changes may be made thereto without departing from the broader spirit and scope of the present disclosure, as set forth in the claims. The specification and drawings are, accordingly, to be regarded as illustrative and not as restrictive. It is understood that the present disclosure is capable of using various other combinations and embodiments and is capable of any changes or modifications within the scope of the inventive concept as expressed herein.

What is claimed is:

1. A method comprising:
receiving a mask pattern of a chip layout;
extracting one or more patterns from the mask pattern;
determining one or more parametric data sets for the one or more patterns;
retrieving one or more calibration parametric data sets based on one or more other mask patterns;
determining a difference between the one or more parametric data sets and the one or more calibration parametric data sets; and
adding the one or more parametric data sets to the one or more calibration parametric data sets if the difference satisfies a threshold value.

2. The method of claim 1, wherein the step of determining one or more parametric data sets comprises:
determining one or more components of the one or more patterns; and
generating one or more flat matrices by removing dimension information of the one or more components,
wherein the one or more parametric data sets includes the one or more flat matrices.

3. The method of claim 2, further comprising:
determining one or more ranges for the dimension information; and
generating one or more dimension matrices for the one or more patterns based on the one or more ranges,
wherein the one or more parametric data sets includes the one or more dimension matrices.

4. The method of claim 3, further comprising:
determining one or more response matrices based on one or more responses of the one or more components to one or more variables of a lithography process,
wherein the one or more parametric data sets includes the one or more response matrices.

5. The method of claim 4, wherein the one or more variables include an intensity variable, a resist contour, an aerial image, or a combination thereof.

6. The method of claim 4, further comprising:
generating a combined matrix based on the one or more flat matrices, the one or more dimension matrices, and the one or more response matrices.

7. The method of claim 6, wherein the step of determining a difference comprises:
retrieving a calibration matrix based on the one or more other mask patterns; and
determining a difference matrix based on a difference between the combined matrix and the calibration matrix.

8. The method of claim 7, further comprising:
determining a difference metric based on the difference matrix,
wherein the difference metric is a Euclidean, zero, or a p-norm of the difference matrix.

9. An apparatus comprising:
at least one processor; and
at least one memory including computer program code for one or more programs, the at least one memory and the computer program code configured to, with the at least one processor, cause the apparatus to perform:
receive a mask pattern of a chip layout;
extract one or more patterns from the mask pattern;
determine one or more parametric data sets for the one or more patterns;
retrieve one or more calibration parametric data sets based on one or more other mask patterns;
determine a difference between the one or more parametric data sets and the one or more calibration parametric data sets; and
add the one or more parametric data sets to the one or more calibration parametric data sets if the difference satisfies a threshold value.

10. The apparatus of claim 9, wherein to perform the step to determine one or more parametric data sets, the apparatus is further caused to:
determine one or more components of the one or more patterns; and
generate one or more flat matrices by removing dimension information of the one or more components,
wherein the one or more parametric data sets includes the one or more flat matrices.

11. The apparatus of claim 10, wherein the apparatus is further caused to:
determine one or more ranges for the dimension information; and
generate one or more dimension matrices for the one or more patterns based on the one or more ranges,
wherein the one or more parametric data sets includes the one or more dimension matrices.

12. The apparatus of claim 11, wherein the apparatus is further caused to:
determine one or more response matrices based on one or more responses of the one or more components to one or more variables of a lithography process,
wherein the one or more parametric data sets includes the one or more response matrices.

13. The apparatus of claim 12, wherein the one or more variables include an intensity variable, a resist contour, an aerial image, or a combination thereof.

14. The apparatus of claim 12, wherein the apparatus is further caused to:
generate a combined matrix based on the one or more flat matrices, the one or more dimension matrices, and the one or more response matrices.

15. The apparatus of claim 14, wherein to perform the step to determine a difference, the apparatus is further caused to:
retrieve a calibration matrix based on the one or more other mask patterns; and
determine a difference matrix based on a difference between the combined matrix and the calibration matrix.

16. The apparatus of claim 15, wherein the apparatus is further caused to:
determine a difference metric based on the difference matrix,
wherein the difference metric is a Euclidean, zero, or a p-norm of the difference matrix.

17. A method comprising:
receiving a mask pattern of a chip layout;
extracting one or more patterns from the mask pattern;
determining one or more components of the one or more patterns;
generating one or more flat matrices by removing dimension information of the one or more components;
determining one or more ranges for the dimension information;
generating one or more dimension matrices for the one or more patterns based on the one or more ranges;
determining one or more response matrices based on one or more responses of the one or more components to one or more variables of a lithography process; and
generating a combined matrix based on the one or more flat matrices, the one or more dimension matrices, and the one or more response matrices.

18. The method of claim 17, further comprising:
retrieving a calibration matrix based on the one or more other mask patterns; and
determining a difference matrix based on a difference between the combined matrix and the calibration matrix.

19. The method of claim 18, further comprising:
determining a difference metric based on the difference matrix,
wherein the difference metric is a Euclidean, zero, or a p-norm of the difference matrix.

20. The method of claim 19, wherein the one or more variables include an intensity variable, a resist contour, an aerial image, or a combination thereof.
